(19) United States
(12) Patent Application Publication
(10) Pub. No.: US 2004/0120522 A1
(43) Pub. Date: Jun. 24, 2004

(54) Image forming apparatus

(75) Inventors: Yuko Takeda, Tenri-shi (JP); Kohji Shinkawa, Kitakatsuragi-gun (JP); Hitoshi Nagahama, Uji-shi (JP); Yoshikazu Kawasaki, Tenri-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 10/731,606

(22) Filed: Dec. 8, 2003

(30) Foreign Application Priority Data
Dec. 13, 2002 (JP) 2002-362567

(51) Int. Cl. H04N 7/167

(52) U.S. Cl. 380/201

(57) ABSTRACT

When an image signal is acquired, an encryption key is created, and the acquired image signal is encrypted with the created encryption key. An image based on the encrypted image signal is formed on a sheet having a memory, and the encryption key is written into the memory. The encrypted image formed on the sheet is read, and the encryption key is read from the memory. The image signal of the read encrypted image is decrypted with the read encryption key, and the original image based on the decrypted image signal is formed on a sheet.

### BACKGROUND OF THE INVENTION

The present invention relates to an image forming apparatus, and more particularly relates to an image forming apparatus suitable for a copying machine and a copying machine system designed to restrict copying actions by using an encryption key system.

In recent years, research and development are actively conducted on protection techniques against unauthorized copying of documents which cause troubles if the contents thereof leak, such as confidential documents within companies and documents relating to privacy. The protection techniques include various methods, and a method in which the content to be protected is copied after encrypting it as disclosed in Japanese Patent Application Laid-Open No. 6-141192 (1994) is known as a typical protection technique.

Moreover, Japanese Patent Applications Laid-Open Nos. 11-215351 (1999) and 2002-99209 disclose a technique for preventing recopying by embedding an encryption key in a sheet so that a copy is seen as a normal copied material and the content thereof is understandable. Further, as techniques similar to the technique of embedding an encryption key in a sheet, it is considered to embed a memory chip in paper money, tickets, etc. so as to prevent counterfeiting.

However, in the case where the content to be protected is encrypted, if the same encryption key is used to encrypt many pieces of image information, a security problem arises, but, if different encryption keys are used, it is hard to determine and manage these keys. Further, in order to decrypt the encrypted image information with a device different from that used for encryption, it is necessary to deliver the encryption key, and there is a possibility that the encryption key may be lost or leak during the delivery. Besides, even if recopying is prevented by embedding an encryption key in paper, there is a fundamental problem that it is easy to copy the paper with the use of a copying machine that does not have an encryption processor.

### BRIEF SUMMARY OF THE INVENTION

The present invention has been made with the aim of solving the above problems, and it is a main object of the present invention to provide an image forming apparatus capable of prohibiting image forming apparatuses having no encryption processor from copying original image information and capable of safely and easily decrypting even image information encrypted by other image forming apparatus.

An image forming apparatus according to the present invention is an image forming apparatus including acquisition means for acquiring an image signal, and image forming means for forming an image based on the image signal acquired by the acquisition means on a sheet having one or a plurality of memories, and comprises: creating means for creating an encryption key when the acquisition means acquires an image signal; encrypting means for encrypting the image signal with the encryption key created by the creating means; and writing means for writing the encryption key into the memory, wherein the image forming means forms an image based on the image signal encrypted by the encrypting means on the sheet.

With this image forming apparatus, an image based on an acquired image signal is formed on a sheet having one or a plurality of memories. An encryption key is created when acquiring the image signal, and the acquired image signal is encrypted with the created encryption key. The encryption key is written into the memory, and the image based on the encrypted, image signal is formed on the sheet having the memory. Accordingly, it is possible to realize an image forming apparatus capable of prohibiting other image forming apparatuses having no encryption processor from copying the original image information.

An image forming apparatus according to the present invention further comprises: image reading means for reading the image formed on the sheet; memory reading means for reading the encryption key from the memory when the image reading means reads the image; and decrypting means for decrypting the image signal of the image read by the image reading means, with the encryption key read by the memory reading means, wherein the image forming means forms an image based on the image signal decrypted by the decrypting means on a sheet.

With this image forming apparatus, an image formed on a sheet having a memory is read, and an encryption key is read from the memory when reading the image. The image signal of the read image is decrypted with the read encryption key, and the image based on the decrypted image signal is formed on a sheet. Accordingly, it is possible to realize an image forming apparatus capable of prohibiting other image forming apparatuses having no encryption processor from copying the original image information and capable of safely and easily decrypting even image information encrypted by other image forming apparatus.

An image forming apparatus according to the present invention is an image forming apparatus including image reading means for reading an image formed on a sheet having one or a plurality of memories storing an encryption key, and image forming means for forming an image on a sheet, based on an image signal of the image read by the image reading means, and comprises: memory reading means for reading the encryption key from the memory when the image reading means reads the image; and decrypting means for decrypting the image signal of the image read by the image reading means, with the encryption key read by the memory reading means, wherein the image forming means forms an image based on the image signal decrypted by the decrypting means on a sheet.

With this image forming apparatus, an image formed on a sheet having one or a plurality of memories storing an encryption key is read, and an image is formed on a sheet based on the image signal of the read image. When reading the image, the encryption key is read from the memory, and the image signal of the read image is decrypted with the read encryption key. An image based on the decrypted image signal is formed on a sheet. Accordingly, it is possible to realize an image forming apparatus capable of safely and easily decrypting even image information encrypted by other image forming apparatus.

An image forming apparatus according to the present invention further comprises information acquiring/creating means for acquiring or creating information about the image encrypted with the encryption key, wherein the writing means writes the encryption key and the information acquired or created by the information acquiring/creating means into the same memory, or different memories.

With this image forming apparatus, information about an image encrypted with an encryption key is acquired or created, and the encryption key and the acquired or created information are written into the same memory or different memories. Accordingly, it is possible to realize an image forming apparatus capable of prohibiting other image forming apparatuses having no encryption processor from copying the original image information and capable of storing the information about the image in a memory.

According to an image forming apparatus of the present invention, the memory reading means reads the encryption key and information about the image encrypted with the encryption key from the same memory, or different memories, when the image reading means reads the image, and the image forming apparatus further comprises display means for displaying the information read by the memory reading means.

With this image forming apparatus, when reading the image, the encryption key and the information about the image encrypted with the encryption key are read from the same memory, or different memories, and the read information is displayed. Accordingly, it is possible to realize an image forming apparatus capable of safely and easily decrypting even image information encrypted by other image forming apparatus and capable of reading the information about the image from the memory and displaying it.

According to an image forming apparatus of the present invention, the information about the encrypted image includes the number of times the image based on the decrypted image signal of the read image was formed, and the writing means writes the number of times obtained by adding one to the number read by the memory reading means into the same memory or different memory so as to update the number of times.

With this image forming apparatus, the number of times obtained by adding one to the read number of times the decrypted image was formed is written into the same memory as the image information, or different memory, so as to update the number of times. Accordingly, it is possible to realize an image forming apparatus capable of safely and easily decrypting even image information encrypted by other image forming apparatus and capable of reading the number of times the formation of image was performed by decrypting the image from the memory and displaying it.

According to an image forming apparatus of the present invention, the image forming means forms a number indicating the number of times obtained by adding one, on the sheet, when forming the image based on the decrypted image signal on the sheet.

With this image forming apparatus, when forming the decrypted image on the sheet, a number indicating the updated number of times is formed on the sheet. Accordingly, it is possible to realize an image forming apparatus capable of safely and easily decrypting even image information encrypted by other image forming apparatus and capable of forming a number indicating the number of times the formation of image was performed by decrypting the image, on a sheet together with the decrypted image.

According to an image forming apparatus of the present invention, the image forming means forms a number indicating the number of times the formation of image was performed by decrypting the image in a visually inconspicuous form within a region where the image is formed.

With this image forming apparatus, a number indicating the number of times the decrypted image was formed is formed in a visually inconspicuous form within the region where the image is formed. Accordingly, it is possible to realize an image forming apparatus capable of safely and easily decrypting even image information encrypted by other image forming apparatus and capable of forming a number indicating the number of times the formation of image was performed by decrypting the image, without interfering with the decrypted image.

According to an image forming apparatus of the present invention, the information about the encrypted image includes the number of times the image based on the decrypted image signal of the read image was formed and a predetermined numerical value, and the image forming apparatus further comprises: judging means for judging whether the number read by the memory reading means is larger or smaller than the predetermined numerical value, and prohibits the decrypting means from decrypting the image signal with the encryption key when the judging means judges that the number is larger.

With this image forming apparatus, when the number of times the read decrypted image was formed is larger than the predetermined numerical value, decryption of the image signal with the encryption key is prohibited. Accordingly, it is possible to realize an image forming apparatus capable of safely and easily decrypting even image information encrypted by other image forming apparatus and capable of preventing the formation of image by decryption of the image from being performed a predetermined number of times or more.

According to an image forming apparatus of the present invention, the information about the encrypted image includes a period, and the image forming apparatus further comprises judging means for judging whether or not a time shown by timer means is within the period read by the memory reading means, and prohibits the decrypting means from decrypting the image signal with the encryption key when the judging means judges that the time is within the read period.

With this image forming apparatus, when the time shown is within the read period, decryption of the image signal with the encryption key is prohibited. Accordingly, it is possible to realize an image forming apparatus capable of safely and easily decrypting even image information encrypted by other image forming apparatus and capable of prohibiting the formation of image by decryption of the image for the predetermined period.

According to an image forming apparatus of the present invention, the information about the encrypted image includes one or a plurality of identifiers of image forming apparatus, the image forming apparatus further comprises: storing means for storing an identifier; and judging means for judging whether or not the identifiers read by the memory reading means include the identifier stored in the storing means, and the decrypting means decrypts the image signal with the encryption key only when the judging means judges that the read identifies include the stored identifier.

With this image forming apparatus, only when the read identifiers include the stored identifier, the image signal is decrypted with the encryption key. Accordingly, it is possible to realize an image forming apparatus capable of safely and easily decrypting even image information encrypted by other image forming apparatus and capable of limiting image forming apparatuses that can form the decrypted image.

According to an image forming apparatus of the present invention, the information about the encrypted image includes a code, the image forming apparatus further comprises: input means for inputting a code; and judging means for judging whether or not the code inputted by the input means and the code read by the memory reading means are identical, and the decrypting means decrypts the image signal with the encryption key only when the judging means judges that the codes are identical.

With this image forming apparatus, only when the inputted code and the read code are identical, the image signal is decrypted with the encryption key. Accordingly, it is possible to realize an image forming apparatus capable of safely and easily decrypting even image information encrypted by other image forming apparatus and capable of limiting the passwords (codes) of persons who are allowed to form the decrypted image.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the configuration of a digital multifunction device as an image forming apparatus of the present invention;

FIG. 2 is a view showing a sheet having memories;

FIG. 3 is a block diagram showing the flow of information when the digital multifunction device of the present invention forms an encrypted image on a sheet having a memory and writes an encryption key into the memory;

FIG. 4 is a block diagram showing the flow of information when the digital multifunction device of the present invention decrypts an encrypted image formed on a sheet having a memory storing an encryption key and forms the original image on a sheet;

FIG. 5 is a block diagram showing the flow of information when the digital multifunction device of the present invention writes information about an image into a memory of a sheet;

FIG. 6 is a flowchart showing the operation performed when the digital multifunction device of the present invention reads information about an image from a memory of a sheet and displays the information on a display;

FIG. 7 is a block diagram showing the flow of information when the digital multifunction device of the present invention outputs a serial number at the (n+1)th output;

FIG. 8 is a flowchart showing an operation of the digital multifunction device of the present invention to judge the number of times of output;

FIG. 9 is a flowchart showing an operation of the digital multifunction device of the present invention to judge an output period;

FIG. 10 is a flowchart showing an operation of the digital multifunction device of the present invention to compare the read serial number and its own serial number; and

FIG. 11 is a flowchart showing an operation of the digital multifunction device of the present invention to judge the ID.

### DETAILED DESCRIPTION OF THE INVENTION

The following description will explain the present invention in detail, based on the drawings illustrating some embodiments thereof.

(First Embodiment)

The first embodiment is a digital multifunction device that comprises a scanner for reading document image digitally, receives an image signal transmitted from a personal computer or the like, processes the received image signal and an image signal of an image read by the scanner, and performs writing on a photoreceptor by light according to the processed image signals so as to form an image by an electrophotographic process.

The encryption system is roughly classified into a common key (symmetric) encryption system and a public key (asymmetric) encryption system. In the common key encryption system, the key used for encryption and the key used for decryption are the same. Whereas in the public key encryption system, the key used for encryption and the key used for decryption differ from each other, and it is possible to keep one of the keys secret (secret key) and publicize the other key (public key). The common key encryption system enables high-speed encryption/decryption, and the first embodiment uses the common key encryption system as an encryption system.

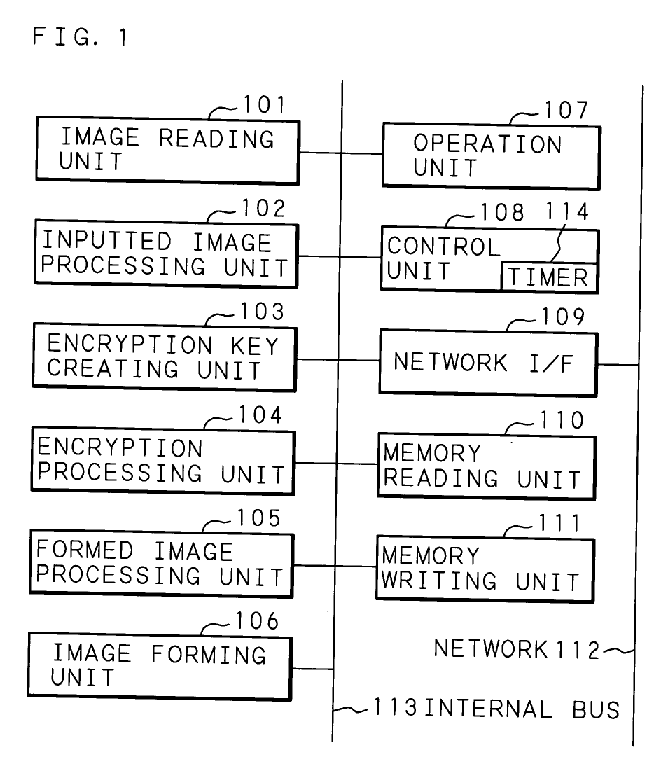

FIG. 1 is a block diagram showing the configuration of a digital multifunction device as an image forming apparatus of the present invention. This digital multifunction device comprises an image reading unit 101, an inputted image processing unit 102, an encryption key creating unit 103, an encryption processing unit 104, a formed image processing unit 105, an image forming unit 106, an operation unit 107, a control unit 108, a network I/F (interface) 109, a memory reading unit 110 and a memory writing unit 111 which are connected to an internal bus 113, and the network I/F 109 is connected to a network 112 to which a personal computer (not shown) or the like is connected. The control unit 108 includes a timer 114 therein.

In this digital multifunction device, the encryption processing unit 104 (encrypting means, decrypting means) encrypts image information transmitted from the personal computer or the like through the network 112 and the network I/F 109 (acquiring means, acquiring/creating means). At this time, the encryption key creating unit 103 (creating means) randomly creates an encryption key for encryption. Note that in this specification, the “image” means any types of information that can be recorded on a sheet, such as characters, charts, graphs, equations as well as still images such as pictures and photographs. Further, the image signal to be encrypted may be an image signal of an image read from a document placed on the document platen (not shown) of the digital multifunction device by a photoelectric conversion element such as a CCD in the image reading unit 101 (image reading means, acquiring means) serving as a scanner.

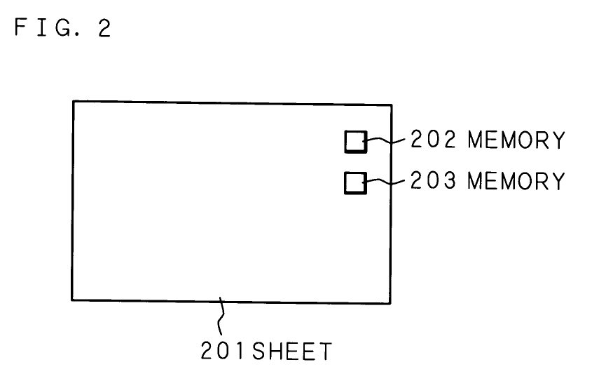

The image signal encrypted in the encryption processing unit 104 is sent to the image forming unit 106 (image forming means). In the image forming unit 106, toner is printed on a one dot per pixel basis on a sheet 201 as shown in FIG. 2 to form an image according to the received image signal. In the sheet 201, as shown in FIG. 2, a memory 202 is added near the edge where the image is not formed. For the memory 202, for example, a battery-less flush memory (EEPROM) is used. When the image forming unit 106 forms the image on the sheet 201, the encryption key used in encrypting the image signal in the encryption processing unit 104 is sent to the memory writing unit 111 (writing means), and written into the memory 202 of the sheet 201 by the memory writing unit 111.

In this case, as the writing method for writing the encryption key into the memory 202 by the memory writing unit 111, either a contact communication method or a non-contact communication method may be used, but the non-contact communication method is more preferable. Besides, the memory 202 is preferably arranged to prohibit writing after writing once so as to prevent alteration of the encryption key. Further, the image of the image signal to be encrypted may be only a portion within an arbitrary range. In this case, the range to be encrypted is specified through the printer driver of the personal computer or the operation unit 107 (input means, acquiring/creating means), and only the image signal within the specified range is encrypted in the encryption processing unit 104.

On the other hand, the image reading unit 101 of this digital multifunction device reads an encrypted image (formed based on the image signal) formed on the sheet 201 having the memory 202 storing the encryption key, and the memory reading unit 110 (memory reading means) reads the encryption key. The read image signal of the image and encryption key are supplied to the encryption processing unit 104. The encryption processing unit 104 decrypts the supplied image signal with the supplied encryption key, and supplies the decrypted image signal to the inputted image processing unit 102. In this case, as the method of reading the encryption key from the memory 202 by the memory reading unit 110, either a contact communication method or a non-contact communication method may be used, but the non-contact communication method is more preferable.

The inputted image processing unit 102 performs processing, such as color balance adjustment and shading correction, on the supplied image signal, and supplies the processed image signal to the formed image processing unit 105. The formed image processing unit 105 performs suitable image processing for forming an image on a paper surface, on the supplied image signal, and supplies the image signal resulting from the image processing to the image forming unit 106. In accordance with the supplied image signal, the image forming unit 106 prints toner on a one dot per pixel basis and forms the decrypted original image.

Note that, for example, the operation unit 107 specifies the operating conditions of the above-mentioned respective units and displays the states by the key operation of a display panel or a touch panel.

The above-mentioned respective units are controlled by the control unit 108. The control unit 108 is composed, for example, of a CPU that operates according to a program recorded in a RAM or a ROM.

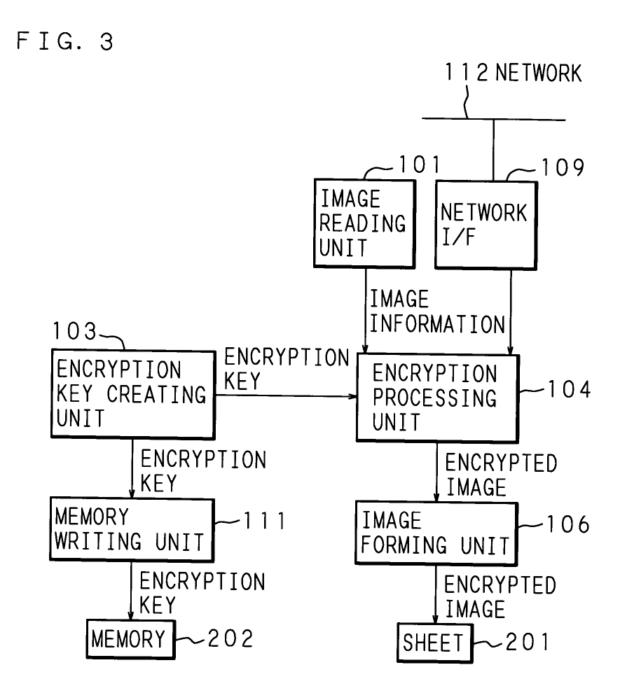

FIG. 3 is a block diagram showing the flow of information when the digital multifunction device with such a configuration forms an encrypted image on the sheet 201 having the memory 202 and writes an encryption key into the memory 202. When this digital multifunction device is instructed to perform encryption processing and printing through the printer driver of the personal computer, not shown, or the operation unit 107, first, the encryption key creating unit 103 creates an encryption key randomly and supplies the created encryption key to the encryption processing unit 104.

Next, in the encryption processing unit 104, the image information (image signal) transmitted from the personal computer through the network 112 and the network I/F 109, or the image information (image signal) of the document read by the image reading unit 101, is encrypted with the encryption key supplied from the encryption key creating unit 103. The encrypted image information (encrypted image) is sent to the image forming unit 106, and an image is formed on the sheet 201 having the memory 202. At this time, the encryption key created by the encryption key creating unit 103 is supplied to the memory writing unit 111, and the memory writing unit 111 writes the encryption key into the memory 202.

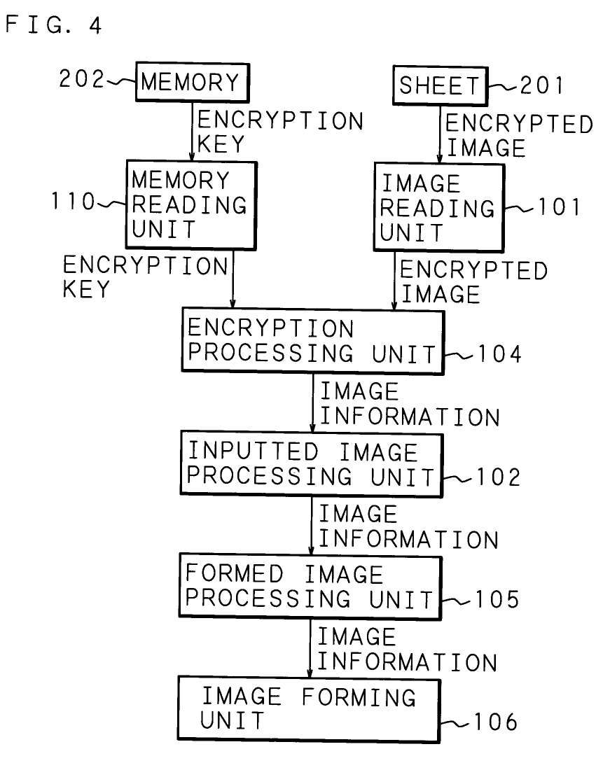

FIG. 4 is a block diagram showing the flow of information when this digital multifunction device decrypts an encrypted image formed on the sheet 201 having the memory 202 storing an encryption key and forms the original image on the sheet. In this digital multifunction device, the encrypted image read by the image reading unit 101 and the encryption key read by the memory reading unit 110 are sent to the encryption processing unit 104, and the encryption processing unit 104 decrypts the encrypted image into the original image with the encryption key. The decrypted original image information undergoes predetermined image processing in the inputted image processing unit 102 and the formed image processing unit 105, and is then sent to the image forming unit 106. The image forming unit 106 forms (copies) the image on a sheet based on the sent image information.

As explained above, according to the first embodiment, since an image is formed by encrypting the image information, it is possible to prohibit copying machines having no encryption processor from copying the original image and allow copying machines having an encryption processor to copy the original image without delivery of the encryption key. Since the encryption key is stored in the memory 202, it cannot be seen, nor copied by a copying machine having no encryption processor.

(Second Embodiment)

The second embodiment is an example of the above-described digital multifunction device of the first embodiment. In this example, the sheet having the memory has two or more memories, information about the image is stored in different memory from the memory for storing the encryption key, and the information about the image is displayed on the display when decrypting the encrypted image into the original image. The “information about the image” mentioned here means information such as the title of image information, the created date of image information, the creator of image information, and the date on which the image was encrypted, but it may be other information if the information can identify the image. Since the configuration of the digital multifunction device of the second embodiment is the same as the configuration (FIG. 1) of the above-described digital multifunction device of the first embodiment, the explanation thereof is omitted.

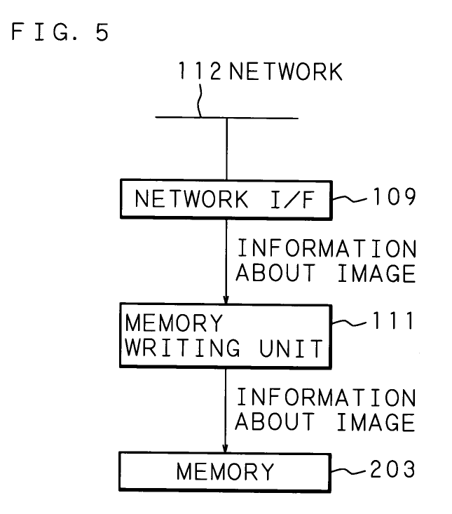

FIG. 5 is a block diagram showing the flow of information when this digital multifunction device writes the information about an image into a memory of a sheet. In the digital multifunction device, the information about an image transmitted from the personal computer through the network 112 and the network I/F 109 is sent to the memory writing unit 111, and the memory writing unit 111 writes the sent information into a memory 203 on the sheet 201 having memories as shown in FIG. 2.

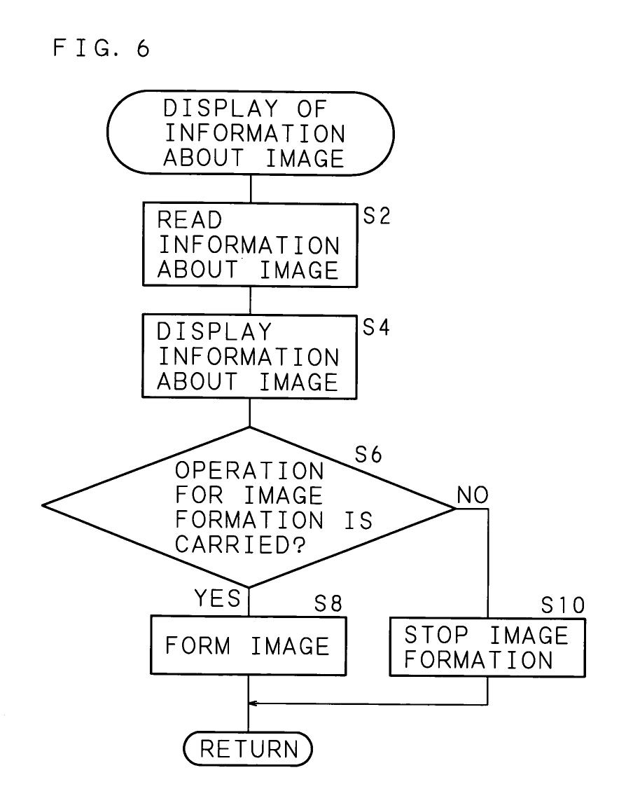

FIG. 6 is a flowchart showing the operation performed when this digital multifunction device reads the information about an image from a memory of a sheet and displays the information on a display. In this digital multifunction device, the memory reading unit 110 reads the information about an image from the memory 203 (S2), and the read information about the image is displayed on the display panel of the operation unit 107 (S4). The user judges whether an encrypted image that the user intends to decrypt and print out is the desired one, from the information about the image displayed on the display panel of the operation unit 107. If the encrypted image is the desired one, the user operates the operation unit 107 to execute printing (image formation), or, if the encrypted image is not the desired one, the user operates the operation unit 107 not to execute printing.

When the operation unit 107 is operated to execute printing (S6: YES), the digital multifunction device decrypts the encrypted image read by the image reading unit 101 into the original image with the encryption key read by the memory reading unit 110, performs image processing on the decrypted image information to form an image on a sheet based on the image information (S8) and performs a return, according to the flow of information shown in FIG. 4 that is explained in the first embodiment. When the operation unit 107 is operated not to execute printing (S6: NO), the digital multifunction device does not read the encrypted image nor read the encryption key, stops image formation (S10) and performs a return.

Note that in the second embodiment, although the encryption key and the information about the image are stored in different memories, they may be stored in the same memory.

(Third Embodiment)

The third embodiment is an example of the above-described digital multifunction device of the first embodiment. In this example, the sheet having the memory has two or more memories, the number of times of output (the number of times the original image was formed by decrypting the encrypted image) is stored in different memory from the memory for storing the encryption key, and a serial number indicating the number of times of output is printed when printing out the decrypted image. Since the configuration of the digital multifunction device of the third embodiment is the same as the configuration (FIG. 1) of the above-described digital multifunction device of the first embodiment, the explanation thereof is omitted.

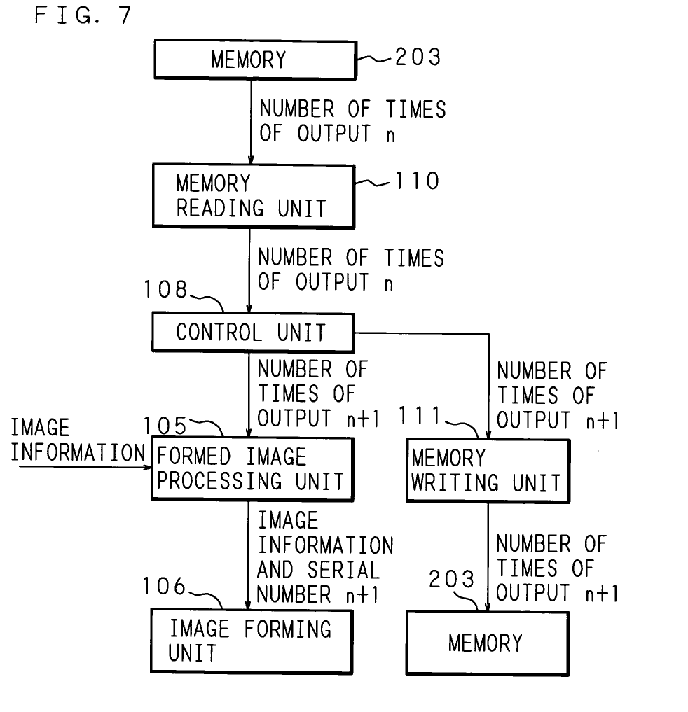

FIG. 7 is a block diagram showing the flow of information when this digital multifunction device outputs the serial number at the (n+1)th output (formation). In this digital multifunction device, the memory reading unit 110 reads the number of times of output performed so far, n, from the memory 203, and the read number of times of output, n, is supplied to the control unit 108. The control unit 108 increments the count of the number of times of output, n, by one to convert it to n+1, and supplies the resulting number to the formed image processing unit 105.

The formed image processing unit 105 sends the image information decrypted in the encryption processing unit 104 (FIG. 4) and the serial number n+1 together to the image forming unit 106, and the image forming unit 106 prints out (forms) the sent image information and serial number n+1 on a sheet. At this time, the control unit 108 also supplies the number of times of output, n+1, to the memory writing unit 111, and the memory writing unit 111 rewrites the number of times of output stored in the memory 203 to n+1.

Thus, by writing the serial number indicating the number of times of output, it is possible to manage the sheets on which the image was printed out. The serial number is preferably printed out so that it overlaps the image information. The reason for this is to make it hard to alter the serial number. Moreover, the serial number is preferably printed out so that it does not interfere with the image information and is inconspicuous to the sight of humans. In the case of a color multifunction device, for example, the serial number is preferably printed out in a color that is not used in the region where the image is formed, particularly in yellow that is inconspicuous to the eyes of humans.

(Fourth Embodiment)

The fourth embodiment is an example of the above-described digital multifunction device of the first embodiment. In this example, the sheet having the memory has two or more memories, the number of times of output (the number of times the original image was formed by decrypting the encrypted image) is stored in different memory from the memory for storing the encryption key, and decryption of the encrypted image is prohibited when the number of times of output stored in the memory exceeds a specified total number of times of output. Although the specified total number of times of output (a predetermined numerical value) can be stored in a memory of a sheet or in the control unit 108 of the digital multifunction device that prints out the image, it is preferably stored in the memory. In this case, the specified total number of times of output can be specified by the user through the printer driver of the personal computer, or the operation unit 107 of the digital multifunction device. Since the configuration of the digital multifunction device of the fourth embodiment is the same as the configuration (FIG. 1) of the above-described digital multifunction device of the first embodiment, the explanation thereof is omitted.

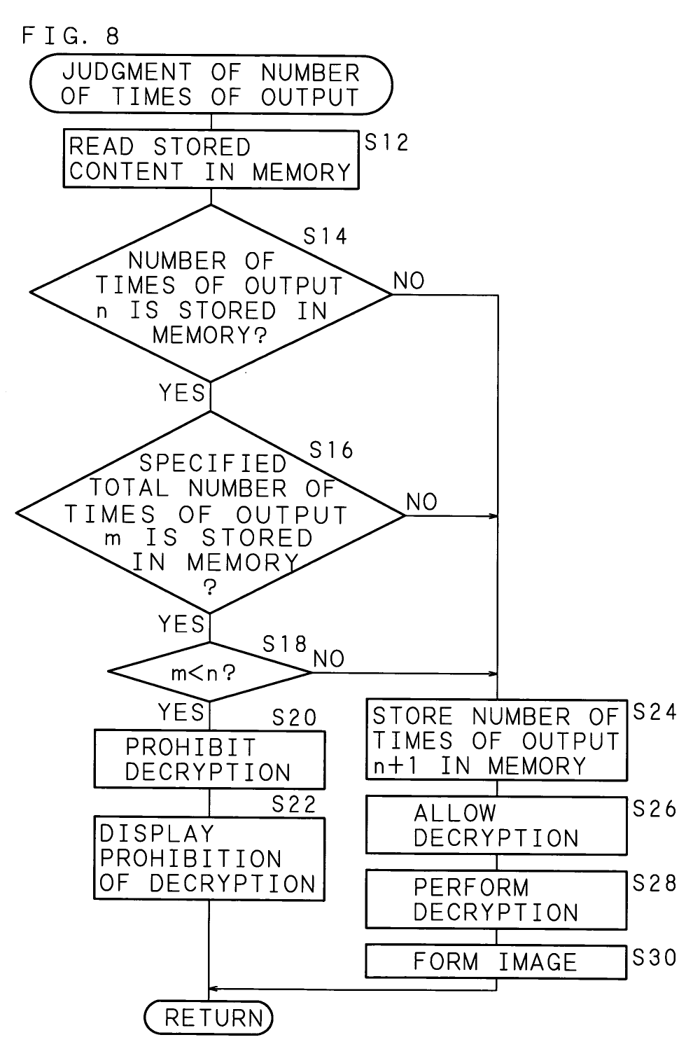

FIG. 8 is a flowchart showing an operation of this digital multifunction device to judge the number of times of output (the number of times the original image was formed by decrypting the encrypted image). In this digital multifunction device, first, the memory reading unit 110 reads the stored content in the memory 203 (S12), and then it is judged whether or not the number of times of output, n, is stored in the memory 203 (S14). If the number of times of output, n, is stored (S 14: YES), it is judged whether or not a specified total number of times of output, m, is stored in the memory 203 (S16). If the specified total number of times of output, m, is stored (S16: YES), the number of times of output, n, and the specified total number of times of output, m, are compared (S18). If the specified total number of times of output, m, is smaller than the number of times. of output, n, (S18: YES), the digital multifunction device prohibits decryption of the encrypted image (S20), displays a message indicating that decryption is prohibited on the display panel of the operation unit 107 (S22) and performs a return. In this case, image formation may be executed by forming the encrypted image as it is, or image formation itself may be prohibited.

If the number of times of output, n, is not stored in the memory 203 (S14: NO), if the specified total number of times of output, m, is not stored in the memory 203 (S16: NO), or if the specified total number of times of output, m, is not smaller than the number of times of output, n, (S18: NO), this digital multifunction device stores n+1 as the number of times of output in the memory 203 (S24), allows decryption of the encrypted image (S26), decrypts the encrypted image read by the image reading unit 101 into the original image with the encryption key read by the memory reading unit 110 (S28), performs image processing on the decrypted image information to form an image on a sheet based on the image information (S30) and performs a return, according to the flow of information shown in FIG. 4 that is explained in the first embodiment.

Thus, by prohibiting decryption from being performed the specified total number of times of output or more, it is possible to prohibit decryption that is not intended by the creator of the image information, and prevent leakage of the image information.

(Fifth Embodiment)

The fifth embodiment is an example of the above-described digital multifunction device of the first embodiment, and prohibits decryption of the encrypted image for a specified period. The period in which decryption of the encrypted image is prohibited may be stored in a memory of a sheet, or stored in the control unit 108 of the digital multifunction device that prints out the image, but is preferably stored in the memory. In this case, the period in which decryption of the encrypted image is prohibited can be specified by the user through the printer driver of the personal computer, or the operation unit 107 of the digital multifunction device. Since the configuration of the digital multifunction device of the fifth embodiment is the same as the configuration (FIG. 1) of the above-described digital multifunction device of the first embodiment, the explanation thereof is omitted.

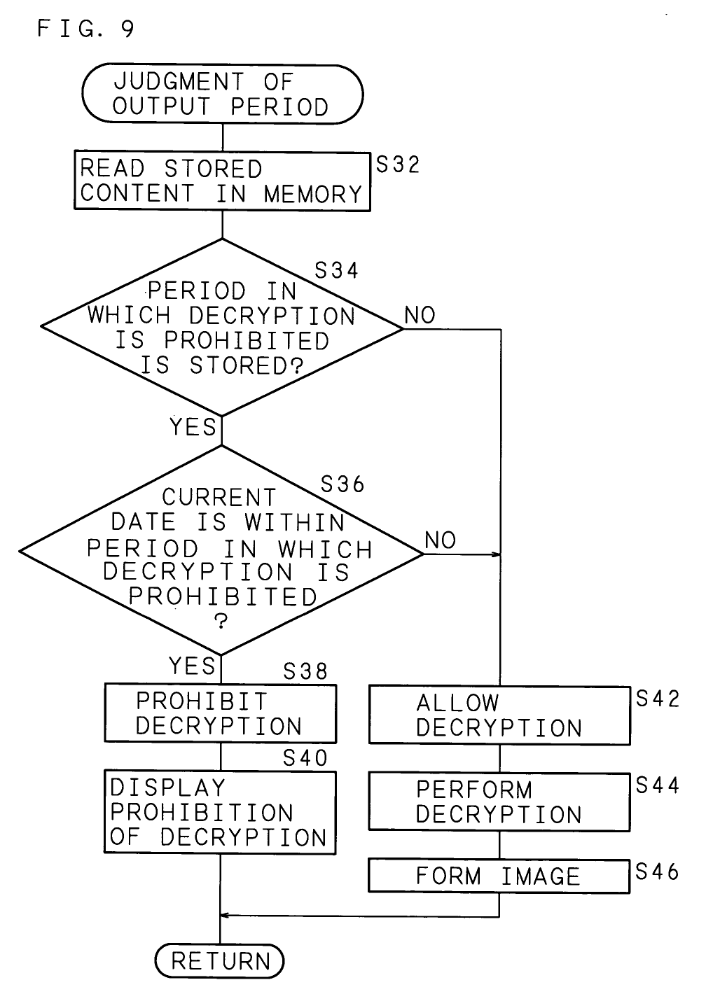

FIG. 9 is a flowchart showing an operation of this digital multifunction device to judge an output period (a period in which decryption of the encrypted image is prohibited). In this digital multifunction device, first, the memory reading unit 110 reads the stored content in the memory 203 (S32), and then judges whether or not a period in which decryption is prohibited is stored in the memory 203 (S34). If a period in which decryption is prohibited is stored (S34: YES), the digital multifunction device judges whether or not the current date obtained from the timer 114 in the control unit 108 is within the period in which decryption is prohibited (S36). If Yes (S36: YES), the digital multifunction device prohibits decryption (S38), displays a message indicating that decryption is prohibited on the display panel of the operation unit 107 (S40) and performs a return. In this case, image formation may be executed by forming the encrypted image as it is, or image formation itself may be prohibited.

If a period in which decryption is prohibited is not stored (S34: NO), or if the current date obtained from the calendar function of this digital multifunction device is not within the period in which decryption is prohibited (S36: NO), the digital multifunction device allows decryption of the encrypted image (S42), decrypts the encrypted image read by the image reading unit 101 into the original image with the encryption key read by the memory reading unit 110 (S44), performs image processing on the decrypted image information to form an image on a sheet based on the image information (S46) and performs a return, according to the flow of information shown in FIG. 4 that is explained in the first embodiment.

Thus, by prohibiting decryption for a specified period, it is possible, for example, to prevent certain information which must be kept confidential for a certain period from leaking for the confidential period, and allow the information to be freely copied after the confidential period. On the other hand, by prohibiting decryption after a specified period, it is possible to prevent wasteful decryption and printout of information when the information is no longer necessary.

(Sixth Embodiment)

The sixth embodiment is an example of the above-described digital multifunction device of the first embodiment, and prohibits machines other than a specified digital multifunction device from decrypting the encrypted image. The information (for example, the serial number) of a digital multifunction device that is allowed to decrypt the encrypted image is preferably stored in a memory of a sheet. In this case, a digital multifunction device that is allowed to decrypt the encrypted image can be specified by the user through the printer driver of the personal computer, or the operation unit 107 of the digital multifunction device. Since the configuration of the digital multifunction device of the sixth embodiment is the same as the configuration (FIG. 1) of the above-described digital multifunction device of the first embodiment, the explanation thereof is omitted.

A serial number (identifier) is added to a digital multifunction device in advance and stored in the control unit 108. In this case, the serial number of a digital multifunction device to be delivered to the A company is arranged to start with “A”, and the serial number of a digital multifunction device to be delivered to the B company is arranged to start with “B”. Further, when printing out image information, which is confidential to outside company, on a sheet having a memory after converting the information into an encrypted image, “the digital multifunction device that is allowed to decrypt the encrypted image is a digital multifunction device with a serial number starting with “A”” is stored in the memory.

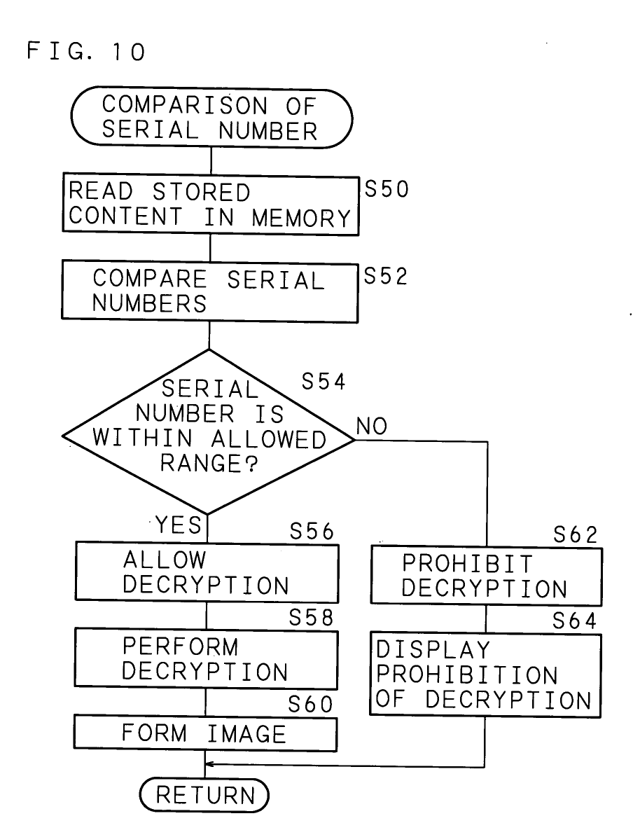

FIG. 10 is a flowchart showing an operation of this digital multifunction device to compare the read serial number and its own serial number. In this digital multifunction device, first, the memory reading unit 110 reads the stored content in the memory 203, for example, “the digital multifunction device that is allowed to decrypt the encrypted image is a digital multifunction device with a serial number starting with “A”” (S50), and then compares “the serial number starting with “A” and its own serial number stored in the control unit 108 (S52). As a result of the comparison, if the own serial number is not within the range of “serial number starting with “A””, this digital multifunction device prohibits decryption (S62), displays a message indicating that decryption is prohibited on the display panel of the operation unit 107, and performs a return. In this case, image formation may be executed by forming the encrypted image as it is, or image formation itself may be prohibited.

If the own serial number is within the range of “serial number starting with “A”” (S54: YES), this digital multifunction device allows decryption of the encrypted image (S56), decrypts the encrypted image read by the image reading unit 101 into the original image with the encryption key read by the memory reading unit 110 (S58), performs image processing on the decrypted image information to form an image on a sheet based on the image information (S60) and performs a return, according to the flow of information shown in FIG. 4 that is explained in the first embodiment.

Thus, for example, it is possible to prohibit a digital multifunction device which is not owned by the A company from performing decryption, and prevent leakage of the information. In this embodiment, although decryption is prohibited depending on companies, decryption may be prohibited depending, for example, on different sections in the same company.

(Seventh Embodiment)

The seventh embodiment is an example of the above-described digital multifunction device of the first embodiment, and prohibits persons other than a specified person from decrypting the encrypted image. The information (ID (Identifier) (code)) of a person who is allowed to decrypt the encrypted image is preferably stored in a memory of a sheet. In this case, the person allowed to decrypt the encrypted image can be specified by the user through the printer driver of the personal computer, or the operation unit 107 of the digital multifunction device. Since the configuration of the digital multifunction device of the seventh embodiment is the same as the configuration (FIG. 1) of the above-described digital multifunction device of the first embodiment, the explanation thereof is omitted.

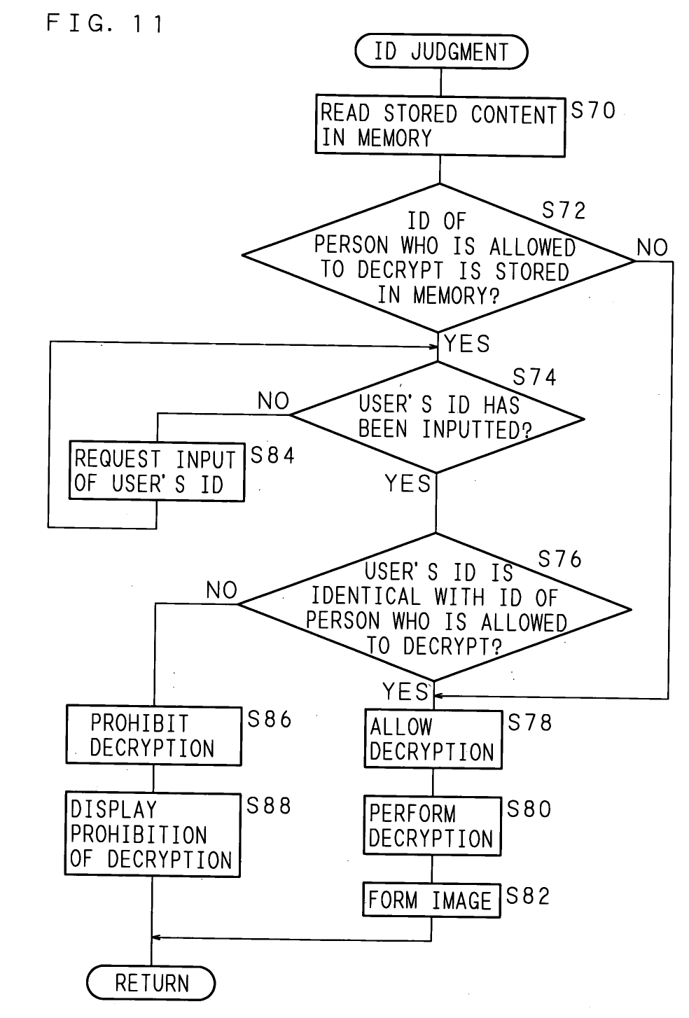

FIG. 11 is a flowchart showing an operation of this digital multifunction device to judge the read ID. In this digital multifunction device, first, the memory reading unit 110 reads the stored content in the memory 203 (S70), and judges whether or not the read stored content includes the ID of the person who is allowed to decrypt the encrypted image (S72). If the read stored content includes the ID of the person allowed to decrypt the encrypted image (S72: YES), the digital multifunction device judges whether or not the user's ID (the ID of the person operating the digital multifunction device) has been inputted (S74). If the user's ID has not been inputted (S74: NO), a message requesting for input of the user's ID is displayed on the display panel of the operation unit 107 (S84).

If the user's ID has been inputted (S74: YES), the digital multifunction device judges whether or not the user's ID is identical with the ID of the person allowed to decrypt the encrypted image (S76). If these IDs are not identical (S76: NO), the digital multifunction device prohibits decryption (S86), displays a message indicating that decryption is prohibited on the display panel of the operation unit 107 (S88) and performs a return. In this case, image formation may be executed by forming the encrypted image as it is, or image formation itself may be prohibited.

If the read stored content does not include the ID of the person allowed to decrypt the encrypted image (S72: NO), or if the user's ID and the ID of the person allowed to decrypt the encrypted image are identical (S76: YES), this digital multifunction device allows decryption of the encrypted image (S78), decrypts the encrypted image read by the image reading unit 101 into the original image with the encryption key read by the memory reading unit 110 (S80), performs image processing on the decrypted image information to form an image on a sheet based on the image information (S82) and performs a return, according to the flow of information shown in FIG. 4 that is explained in the first embodiment.

Thus, by prohibiting persons other than the allowed person from decrypting the encrypted image, it is possible to prevent leakage of the information.

According to the image forming apparatus of the present invention, it is possible to prohibit other image forming apparatuses having no encryption processor from copying the original image information, and prevent leakage of the information. Moreover, it is possible to safely and easily decrypt even image information that was encrypted by other image forming apparatus, without requiring delivery of the encryption key.

According to the image forming apparatus of the present invention, it is possible to store information about an encrypted image in a memory. It is also possible to read the information about the image from the memory and display it. Further, it is possible to prevent the encrypted image from being decrypted and printed out by mistake.

According to the image forming apparatus of the present invention, it is possible to read the number of times the formation of image was performed by decrypting the encrypted image from a memory and display the number, and manage the sheets on which the decrypted image was formed.

According to the image forming apparatus of the present invention, a number indicating the number of times the formation of image was performed by decrypting the encrypted image can be formed together with the decrypted image on a sheet, thereby making it difficult to alter the number indicating the number of times the image was formed. Moreover, the number indicating the number of times the image was formed can be formed without interfering with the decrypted image.

According to the image forming apparatus of the present invention, it is possible prevent the formation of image by decryption of the encrypted image from being performed a predetermined number of times or more. It is also possible to prohibit the formation of image by decryption of the encrypted image for a predetermined time. By prohibiting decryption after the passage of a specified period, it is possible to prevent decryption and printout of an image when the image is no longer necessary.

According to the image forming apparatus of the present invention, it is possible to limit image forming apparatuses that can form an image by decrypting the encrypted image. It is also possible to limit the passwords (codes) of persons who are allowed to form an image by decrypting the encrypted image.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image forming apparatus including an acquisition unit for acquiring an image signal, and an image forming unit for forming an image based on the image signal acquired by said acquisition unit on a sheet having one or a plurality of memories, comprising:
an encryption key creating unit for creating an encryption key when said acquisition unit acquires an image signal;
an encrypting unit for encrypting the image signal with the encryption key created by said encryption key creating unit; and
a writing unit for writing the encryption key into the memory,
wherein said image forming unit forms an image based on the image signal encrypted by said encrypting unit on the sheet.

2. The image forming apparatus of claim 1, further comprising:
an image reading unit for reading the image formed on the sheet;
a memory reading unit for reading the encryption key from the memory when said image reading unit reads the image; and
a decrypting unit for decrypting the image signal of the image read by said image reading unit, with the encryption key read by said memory reading unit,
wherein said image forming unit forms an image based on the image signal decrypted by said decrypting unit on a sheet.

3. The image forming apparatus of claim 1, further comprising an information acquiring/creating unit for acquiring or creating information about the image encrypted with the encryption key,
wherein said writing unit writes the encryption key and the information acquired or created by said information acquiring/creating unit into the same memory, or different memories.

4. The image forming apparatus of claim 2,
wherein said memory reading unit reads the encryption key and information about the image encrypted with the encryption key from the same memory, or different memories, when said image reading unit reads the image, and said image forming apparatus further comprises a display unit for displaying the information read by said memory reading unit.

5. The image forming apparatus of claim 4, wherein
the information read by said memory reading unit includes the number of times the image based on the decrypted image signal of the read image was formed, and said writing unit writes the number of times obtained by adding one to the number read by said memory reading unit into the same memory or different memory so as to update the number of times.

6. The image forming apparatus of claim 5, wherein
said image forming unit forms a number indicating the number of times obtained by adding one on the sheet when forming the image based on the decrypted image signal on the sheet.

7. The image forming apparatus of claim 6, wherein
said image forming unit forms the number in a visually inconspicuous form within a region where the image is formed.

8. The image forming apparatus of claim 5, wherein
the information read by said memory reading unit includes the number of times the image based on the decrypted image signal of the read image was formed and a predetermined numerical value, and said image forming apparatus further comprises: a judging unit for judging whether the number read by said memory reading unit is larger or smaller than the predetermined numerical value; and a prohibiting unit for prohibiting said decrypting unit from decrypting the image signal with the encryption key when said judging unit judges that the number is larger.

9. The image forming apparatus of claim 4, wherein
the information read by said memory reading unit includes a period, and said image forming apparatus further comprises: a timer; a judging unit for judging whether or not a time shown by said timer is within the period read by said memory reading unit; and a prohibiting unit for prohibiting said decrypting unit from decrypting the image signal with the encryption key when said judging unit judges that the time is within the read period.

10. The image forming apparatus of claim 4, wherein
the information read by said memory reading unit includes one or a plurality of identifiers of image forming apparatus,
said image forming apparatus further comprises: a storing unit for storing an identifier; and a judging unit for judging whether or not the identifiers read by said memory reading unit include the identifier stored in said storing unit, and
said decrypting unit decrypts the image signal with the encryption key only when said judging unit judges that the read identifies include the stored identifier.

11. The image forming apparatus of claim 4, wherein
the information read by said memory reading unit includes a code,
said image forming apparatus further comprises: an input unit for inputting a code; and a judging unit for judging whether or not the code inputted by said input unit and the code read by said memory reading unit are identical, and
said decrypting unit decrypts the image signal with the encryption key only when said judging unit judges that the codes are identical.

12. An image forming apparatus including an image reading unit for reading an image formed on a sheet having one or a plurality of memories storing an encryption key, and an image forming unit for forming an image on a sheet, based on an image signal of the image read by said image reading unit, comprising:
a memory reading unit for reading the encryption key from the memory when said image reading unit reads the image; and
a decrypting unit for decrypting the image signal of the image read by said image reading unit, with the encryption key read by said memory reading unit,
wherein said image forming unit forms an image based on the image signal decrypted by said decrypting unit on a sheet.

13. The image forming apparatus of claim 12, wherein
said memory reading unit reads the encryption key and information about the image encrypted with the encryption key from the same or different memories when said image reading unit reads the image, and said image forming apparatus further comprises a display unit for displaying the information read by said memory reading unit.

14. The image forming apparatus of claim 13, wherein
the information read by said memory reading unit includes the number of times the image based on the decrypted image signal of the read image was formed, and said writing unit writes the number of times obtained by adding one to the number read by said memory reading unit into the same memory or different memory so as to update the number of times.

15. The image forming apparatus of claim 14, wherein
said image forming unit forms a number indicating the number of times obtained by adding one on the sheet when forming the image based on the decrypted image signal on the sheet.

16. The image forming apparatus of claim 15, wherein
said image forming unit forms the number in a visually inconspicuous form within a region where the image is formed.

17. The image forming apparatus of claim 14, wherein
the information read by said memory reading unit includes the number of times the image based on the decrypted image signal of the read image was formed and a predetermined numerical value, and said image forming apparatus further comprises: a judging unit for judging whether the number read by said memory reading unit is larger or smaller than the predetermined numerical value; and a prohibiting unit for prohibiting said decrypting unit from decrypting the image signal with the encryption key when said judging unit judges that the number is larger.

18. The image forming apparatus of claim 13, wherein
the information read by said memory reading unit includes a period, and said image forming apparatus further comprises: a timer; a judging unit for judging whether or not a time shown by said timer is within the period read by said memory reading unit; and a prohibiting unit for prohibiting said decrypting unit from decrypting the image signal with the encryption key when said judging unit judges that the time is within the read period.

19. The image forming apparatus of claim 13, wherein
the information read by said memory reading unit includes one or a plurality of identifiers of image forming apparatus,
said image forming apparatus further comprises: a storing unit for storing an identifier; and a judging unit for judging whether or not the identifiers read by said memory reading unit include the identifier stored in said storing unit, and
said decrypting unit decrypts the image signal with the encryption key only when said judging unit judges that the read identifies include the stored identifier.

20. The image forming apparatus of claim 13, wherein
the information read by said memory reading unit includes a code,
said image forming apparatus further comprises: an input unit for inputting a code; and a judging unit for judging whether or not the code inputted by said input unit and the code read by said memory reading unit are identical, and
said decrypting unit decrypts the image signal with the encryption key only when said judging unit judges that the codes are identical.
